(19) United States
(12) Patent Application Publication
(10) Pub. No.: US 2005/0112953 A1
(43) Pub. Date: May 26, 2005

(54) Slotted contact retention and alignment device for contact assembles

(76) Inventor: Lloyd G. Ratchford, Oneonta, NY (US)

Correspondence Address: BLANK ROME LLP, 600 NEW HAMPSHIRE AVENUE, N.W., WASHINGTON, DC, 20037, US

(21) Appl. No.: 10/720,676

(22) Filed: Nov. 25, 2003

(51) Int. Cl. H01R 13/502

(52) U.S. Cl. 439/695

(57) ABSTRACT

The present invention is directed towards a contact retention system having a outer contact body, a front spacer, contacts, a rear spacer and a cable ferrule. The rear spacer holds the contacts in position during assembly and use of the cable. The rear spacer is a generally cylindrical-shaped structure having U-shaped slots equally spaced around its circumference, each slot holding and positioning a single contact for insertion into the front spacer. The rear spacer is made of a dielectric material and insulates each conductor from the other conductors.

### FIELD OF INVENTION

The present invention is directed to a contact positioning assembly for a cable having a slotted rear spacer for positioning individual contacts of a cable for insertion into a front spacer.

### BACKGROUND OF THE INVENTION

Electrical and data cables have conductors that are located in specific positions in order to properly connect to and engage corresponding conductors of other cables or devices. If the conductors are not properly positioned, the cable may not “hook up” with corresponding cables or devices, or the conductors may not properly engage the corresponding conductors, resulting in a weakened or non-existent connection. Therefore, it is critical that the conductors be properly positioned.

With this in mind, manufacturers have been attempting to find ways to position conductors using inexpensive and time-saving methods. One approach has been to use mating faces and grommets, such as those shown in U.S. Pat. No. 5,099,572 to Lazaro, Jr. et al. and U.S. Pat. No. 5,603,641 to Kuhn et al., respectively. Both these references disclose structures having a plurality of holes therein for holding conductors in a spaced apart relationship at a terminal end of a cable. However, because the structures have holes, the conductors must be carefully inserted through the ends of the holes, which can be difficult and time-consuming, resulting in high manufacturing costs for the cable.

Radiall S. A. of France has developed a spacer for holding four conductors, the spacer having two adjacent U-shaped grooves with an open side directed radially outward. Each groove of the Radiall S. A. spacer is designed to hold two conductors. Because the U-shaped grooves have an open side, the conductors may be inserted sideways into the spacer, rather than through an opening in the spacers end. This allows for easier insertion of the conductors and consequently, lowers manufacturing costs. However, the spacer developed by Radiall S. A. only includes two grooves for holding four conductors. This results in two conductors in each groove so that the conductors are not securely positioned in their respective groove, allowing the conductors to slide up and down in the groove.

Therefore, it would be advantageous to provide a spacer having multiple U-shaped grooves for easy insertion of a conductor, and so that each conductor is securely positioned in its own groove.

### SUMMARY OF THE INVENTION

The present invention is directed to a spacer for an electrical/data cable having multiple U-shaped slots for holding separate conductors, so that each slot holds a single conductor. The spacer secures the contacts in a fixed position during the cable's assembly and its subsequent use. The plurality of slots are equally spaced around the circumference of the spacer and position the contacts for insertion into a front spacer. The U-shaped slots have a radially open side so that the conductors can be inserted therethrough. The slot provides a quick and simple means of inserting the conductors into the spacer, thereby lowering the manufacturing cost of the cable.

### BRIEF DESCRIPTION OF THE DRAWINGS

FIG. 1 shows an exploded view of the contact retention assembly of the present invention;

FIG. 2 shows a side view of a cable with four unsecured contacts extending therefrom;

FIG. 3 shows a perspective view of the spacer of the present invention;

FIG. 4 shows an end view along line 4-4 of FIG. 3 of the spacer of the present invention; and

FIG. 5 shows side view of the four contacts secured in the spacer.

### DETAILED DESCRIPTION OF DRAWINGS

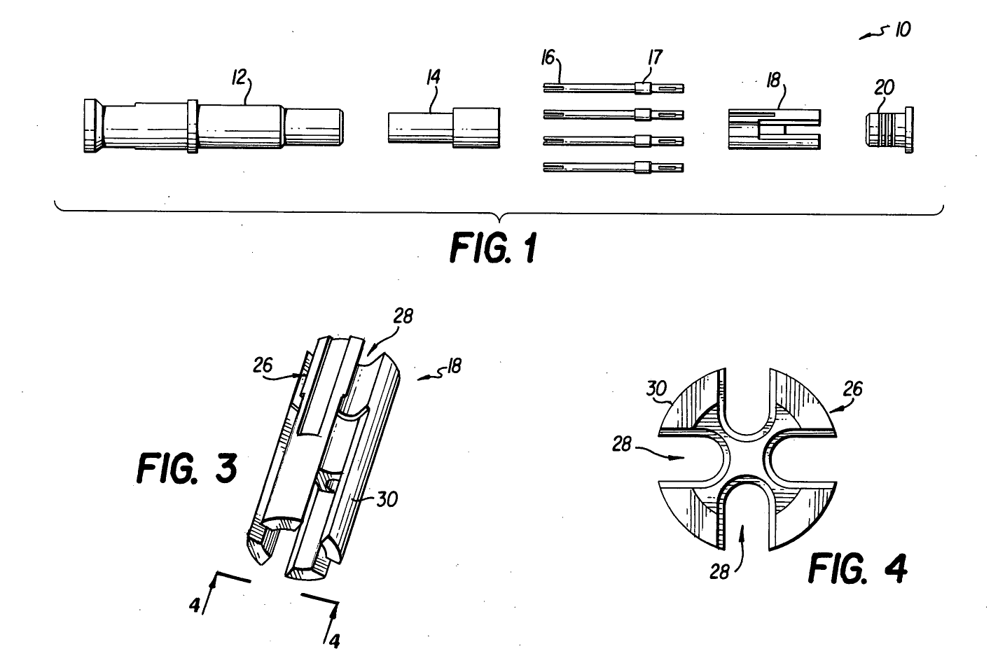

Referring now in detail to the drawings, FIG. 1 shows an exploded view of the various components of a contact positioning assembly 10, having an outer contact body 12, a front spacer 14, contacts 16, a rear spacer 18 and a cable ferrule 20.

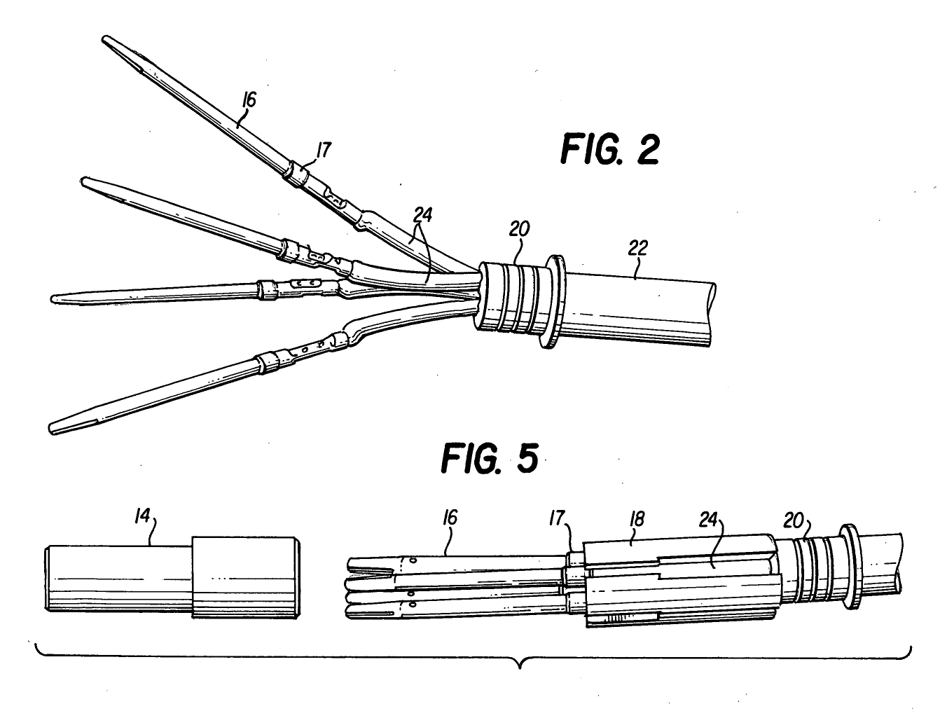

FIG. 2 shows an electrical/data cable 22 whose end is stripped, exposing four conductors 24 that are secured to four contacts 16. The contacts 16 have a ring 17 around a bottom portion thereof which position the contacts 16 in the rear spacer as described below.

FIGS. 3 and 4 show the rear spacer 18 in more detail. The rear spacer 18 is a cylindrically-shaped positioning device that holds the contacts 16 in a secure position for insertion into the front spacer 14. The rear spacer 18 comprises a base portion 26 having four generally U-shaped slots 28 equally spaced around its circumference. The slots 28 extend along the longitudinal length of the base portion 26, with an opening directed radially away from the longitudinal axis.

Although the description of the invention recites four slots 28 in the rear spacer 18, it should be understood that any number of slots may be used so long as the number of slots 28 correspond to the number of contacts 16 present.

The walls 30 separating the slots 28 extend from the base portion 26, as best shown in FIG. 3, to form a generally circular enclosure. The walls 30 are configured so that the slot openings are slightly more narrow than the diameter of the conductors 24 so that the conductors 24 must be forcibly inserted through the slot openings. The walls 30 therefore provide a frictional interference with the conductors 24 to resiliently hold the conductors 24 in place. Additionally, the walls 30 provide an insulating means for each contact 16 to reduce any electrical interference from an adjacent contact 16. In this regard, the rear spacer is preferably made of a dielectric material, such as Teflon.

When assembled, the four conductors 24 are secured in the slots 28 of the rear spacer 18, as shown in FIG. 5, to properly position and align the contacts 16 for insertion into the front spacer 14. The rings 17 abut the base portion 26 of the rear spacer 18 and the cable ferrule 20 abuts a top surface of the walls 30 to securely hold the rear spacer 18 between the rings 17 and the cable ferrule 20. This prevents the conductors 24 from inadvertently moving with respect to the rear spacer 18.

The front spacer 14 is inserted over the contacts 16 and positioned proximate to the rear spacer 18. The outer contact body 12 is then placed over the front spacer 14 to complete assembly of the contact positioning assembly 10. The rear spacer 18 holds the contacts 16 in position during the entire assembly process, and subsequently, during the cable's use.

1. A contact positioning assembly for a cable comprising:
a plurality of contacts attached to conductors of an electrical cable, the conductors secured in radially outward facing U-shaped slots of a first spacer for positioning the conductors, the number of slots corresponding to the number of conductors so that each slot holds a single conductor;
wherein said first spacer is generally cylindrical-shaped with the slots equally spaced around its circumferences; and wherein a base portion of the first spacer engages rings on the contacts to hold the contacts in a secure position to prevent the contacts from sliding; and
wherein the slots are sized smaller than an outside diameter of the conductors so as to provide a frictional interference between the slots and conductors for securely holding the conductors in the slots.

2. The contact positioning assembly of claim 1, wherein:
there are four slots and four conductors.

3. canceled

4. The contact positioning assembly of claim 3, wherein:
the slots are separated by walls, the walls extending above the slots and abutting a cable ferrule, the ferrule securing the first spacer between itself and the rings.

5. The contact positioning assembly of claim 3, further comprising:
a second spacer that slides over the contacts and is positioned adjacent the first spacer.

6. The contact positioning assembly of claim 3, wherein:
the first spacer is made of a dielectric material to provide electrical shielding.

7. A spacer for positioning conductors of an electrical cable comprising:
a generally cylindrical spacer having U-shaped slots equally spaced around the circumference of the spacer, the slots having openings facing radially outward and being dimensioned slightly smaller than the diameter of the conductors so as to provide frictional interference to hold the conductors, and the slots being adapted to hold a single conductor, wherein a base portion of the spacer is adapted to abut and secure contact rings, wherein the spacer is secured between the cable ferrule and the contact rings.

8. The spacer of claim 7 wherein the spacer is made of a dielectric material.

9. The spacer of claim 7 wherein the slots are separated by walls that extend above the slots, a top portion of the walls being adapted to abut a cable ferrule.
